(19) United States
(12) Patent Application Publication
(10) Pub. No.: US 2015/0252726 A1
(43) Pub. Date: Sep. 10, 2015

(54) EXPANDED GAS POWER PLANT FOR ENERGY STORAGE

(71) Applicant: Siemens Aktiengesellschaft, München (DE)

(72) Inventors: Christian Brunhuber, Auerbach (DE); Katja Knobloch, Baiersdorf/Hagenau (DE); Wolfgang Menapace, Erlangen (DE); Frank Strobelt, Nurnberg (DE); Nicolas Vortmeyer, Erlangen (DE); Gerhard Zimmermann, Hochstadt/Aisch (DE)

(73) Assignee: SIEMENS AKTIENGESELLSCHAFT, Munich (DE)

(21) Appl. No.: 14/427,826

(22) PCT Filed: Jun. 19, 2013
(86) PCT No.: PCT/EP2013/062743

§ 371 Date: Mar. 12, 2015

(30) Foreign Application Priority Data
Sep. 18, 2012 (EP) 12184832.9

(51) Int. Cl. F02C 6/14; F01K 3/00; F01K 23/10; F02C 6/18

(52) U.S. Cl. CPC F02C 6/14; F02C 6/18; F01K 3/00; F01K 23/10

(57) ABSTRACT

A method for operation of a gas power plant, and to a gas power plant of this type, comprising a gas turbine, which is connected to a generator that can also be operated as a motor and which is thermally coupled to a water vapour circuit by way of a first heat exchanger are provided. The method includes: operating the generator as a motor in such a way that a heated gas flow is discharged from the gas turbine; thermally treating of water in the water vapour circuit via the first heat exchanger by the heated gas flow; storing of the water thermally treated in this way in a vapour accumulator; operating a steam turbine with water vapour taken from the vapour accumulator; diverting of the water vapour after interaction with the steam turbine into a vapour chamber for condensation; and collecting of the condensed water in a condensate reservoir.

### CROSS REFERENCE TO RELATED APPLICATIONS

This application is the US National Stage of International Application No. PCT/EP2013/062743 filed Jun. 19, 2013, and claims the benefit thereof. The International Application claims the benefit of European Application No. EP12184832 filed Sep. 18, 2012. All of the applications are incorporated by reference herein in their entirety.

### FIELD OF INVENTION

The present invention relates to a method for operating a gas power plant, comprising a gas turbine which is connected to a generator that can also be operated as a motor, and which is thermally coupled to a steam circuit via a first heat exchanger. The present invention also relates to such a gas power plant.

### BACKGROUND OF INVENTION

The rapid roll-out of renewable energy sources, which typically feed into the public supply network electrical power which varies markedly over time, has resulted in numerous challenges with respect to network stability and with respect to the measures necessary to achieve this network stability.

Hitherto, conventional fossil fuel-powered power plants have still been capable of delivering sufficient network reserves for the renewable energy sources, such that network instabilities can be avoided. However, it is already apparent that in the future a number of these power plants will no longer be capable of providing these network services, as they will have to be operated at ever-diminishing capacity. Consequently, it is necessary to undertake further technical measures which make it possible to maintain network stability. Such technical measures may reside in a suitable retrofit in order to improve the flexibilization of the renewable energy sources, as well as in an improved network extension or in the installation of so-called “phase-shifters” (synchronous generators).

Further technical measures, which can contribute to network stabilization, are also e.g. integrating into the public supply network energy storage units which can make it possible to temporarily store electrical power in a time-dependent manner. The temporary storage can in this context take place in a suitable physical or chemical form. For this reason too, temporary storage units are particularly well-suited to network stabilization as they are capable of drawing excess electrical current out of the public supply network in order to make this current available once again to the network at a later point.

A disadvantage of such temporary storage is, however, that every storage procedure, or the attendant energy conversion processes, results in a loss of power caused by the system. The power losses arising in this context can be greater than the power fed back into the public supply network at a later point. As a consequence, many of the solutions for the temporary storage of excess electrical current which are currently known and have been discussed up to now suffer from a storage and power ratio that is not sufficiently efficient.

An attempt to avoid these problems known from the prior art is made by the approach of DD 99415 A2 in conjunction with DD 91150 A1. Both laid-open applications describe an air storage gas turbine installation in which a gas turbine compressor or an auxiliary compressor is driven by an electric motor in order to compress atmospheric air and to heat it as a consequence of the compression. The air compressed in this manner is supplied to an air storage container for later use. The waste heat generated during compression can be supplied to a waste heat boiler in which, for example, steam can be prepared for immediate use, for example in a steam power plant. Equally, the steam can be supplied to a storage unit for later use.

However, a disadvantage of such an approach is that the use of the waste heat is still not sufficiently efficient. Equally, the installation known from the prior art cannot achieve the degree of flexibilization of a power plant installation that is currently required.

### SUMMARY OF INVENTION

The present invention is hence based on an object of avoiding these drawbacks known from the prior art, and proposing temporary storage of electrical current from the public supply networks which is both efficient in terms of the power balance and also possible with respect to technical realization without great expenditure. In particular, an object is to include making improved use of the waste heat, while in particular a good degree of flexibilization of the power plant installation should be achieved at the same time. Furthermore, the present invention should make it possible to temporarily store electrical power drawn from the public supply networks, which can be effected without cost-intensive changes on the basis of already-installed power plants. It is in addition an object of the invention to modify existing power plant installations such that they are improved in terms of their flexibilization.

These objects, on which aspects of the invention are based, are achieved by a method and by a gas power plant as claimed.

In particular, these objects are achieved by a method for operating a gas power plant which comprises a gas turbine which is connected to a generator that can also be operated as a motor, and which is thermally coupled to a steam circuit via a first heat exchanger, the method having the following steps:—operating the generator as a motor such that a heated gas stream exits the gas turbine;—thermally conditioning water in the steam circuit via the first heat exchanger by means of the heated gas stream;—storing the thus thermally conditioned water in a steam storage unit;—operating a steam turbine with steam drawn from the steam storage unit;—discharging the steam, after interaction with the steam turbine, into a steam space for condensation;—collecting the condensed water in a condensate storage unit, wherein the steam space and the condensate storage unit are two separate containers connected by at least one line, and wherein in particular the steam space can be supplied with the condensed water from the condensate storage unit.

The objects on which aspects of the invention is based are also achieved by a gas power plant, which comprises a gas turbine which is connected to a generator that can also be operated as a motor, and which is thermally coupled to a steam circuit via a first heat exchanger such that, when the generator is operated as a motor, a gas stream exiting the gas turbine thermally conditions water in the steam circuit drawn from a cold water storage unit, wherein the first heat exchanger is furthermore fluidically connected to a steam storage unit such that the water can be stored as steam in the steam storage unit after thermal conditioning, and further comprising a steam turbine which is fluidically connected to the steam storage unit such that it can be supplied with steam from the steam storage unit, wherein the steam, after interaction with the steam turbine, is fed to a steam space interacting fluidically with a condensate storage unit for condensation, and wherein in particular the condensate storage unit is fluidically connected to the cold water storage unit such that condensed water from the condensate storage unit can be supplied to the cold water storage unit, and wherein the steam space and the condensate storage unit are two separate containers connected by at least one line, and wherein in particular the steam space can be supplied with the condensed water from the condensate storage unit.

According to aspects of the invention, the method thus uses a gas turbine which is not only suitable for generating electrical current during firing but which can also be operated by means of a motor such that, when consuming electrical energy, heat is generated. To that end, the generator interacting with the gas turbine is operated as a motor, wherein in the compressor stage of the gas turbine an adiabatic compression of the intake air leads to an increase in the temperature of this intake air. Thus, electrical energy is converted into thermal energy. The thermal energy generated in this manner is then made use of after exiting the gas turbine in that water in a steam circuit is conditioned by means of a first heat exchanger using the heated gas stream exiting the gas turbine. In this context, the heated gas stream exits the turbine stage after expansion, since this requires the least structural changes.

The thermal energy transferred to the water can be prepared for later use by suitably storing the water, which has been thermally conditioned in this manner, in a steam storage unit. In order to transform the temporarily stored thermal energy back into electrical energy at a later point, in order to make it available to the public supply networks, the water stored in the steam storage unit can be drawn therefrom in order to operate a steam turbine. In this context, the steam exiting the steam turbine is also typically still at a sufficiently high temperature to be useful for further subsequent uses. According to the invention, this steam exiting the steam turbine is then condensed in a steam space and is collected as water in a suitable condensate storage unit. The condensed water, which is still hot enough for further uses, can be drawn from this condensate storage unit at a later point.

According to aspects of the invention, it is thus possible to adapt a gas power plant in terms of its construction and with respect to the power plant processes such that it is suited to using electrical power from the public supply networks if for example excess current is available. In this context, the gas power plant is typically used both for charging operation and discharging operation. In charging operation, electrical energy is drawn from the public supply networks and is transformed into thermal energy which can then be temporarily stored in thermally conditioned water in a steam storage unit. In discharging operation, by contrast, this thermal energy is retrieved from the steam storage unit and is converted back into electrical power with the aid of a steam turbine. The quantity of thermal power still unused after the conversion back into electrical power can again be temporarily stored at a lower temperature in order to be made available at a later point and/or for further uses. Only once this additional thermal power, which would otherwise remain unused, has been retrieved is the water of the steam circuit supplied to, in particular, the cold water storage unit, whence at a later point during charging operation it is possible to again draw the water that is thermally conditioned by means of the first heat exchanger.

It is consequently possible, by means of constructive and process engineering measures of low technical complexity, to adapt an existing gas power plant such that it can also be made suitable for converting electrical current into heat and for thermal temporary storage. To that end, only a slight adaptation of the generator interacting with the gas turbine is necessary in order that the generator can be operated as a motor. Furthermore, it is necessary to provide a suitable steam circuit which can possibly make use of existing components (lines and storage containers) of the power plant installation.

It is further provided according to aspects of the invention that the steam space and the condensate storage unit are two separate containers connected by at least one line, wherein in particular the steam space can be supplied with the condensed water from the condensate storage unit. The steam exiting the steam turbine is cooled in the steam space until it condenses. The condensed water drawn from the condensate storage unit serves in particular in this context as a cold source. By suitably adjusting the pressure ratios in the condensate storage unit or the steam space, the time point of the condensation can be advantageously influenced. It is thus possible, for example, to set a desired target temperature in the condensate storage unit by means of a suitable choice of the pressure ratios therein. If for example a temperature of over 100° C. is to be set, it is accordingly necessary to set an increased pressure. Although reduced pressure in the steam space allows the entire steam process to run more efficiently, it is then occasionally necessary to provide suitable pumps and valves for the exchange of water between the steam space and the condensate storage unit, which make the exchange more complex.

According aspects of to the invention, the spatial separation between the steam space and the condensate storage unit permits not only the setting of suitable pressure and temperature ratios in the steam space which promote condensation, but also makes it possible at the same time to temporarily store the condensed water in the condensate storage unit. In this context, the water condensed in the steam space is supplied to the condensate storage unit for temporary storage. The water temporarily stored in the condensate storage unit can be supplied back to the steam space in the manner of a circuit (between condensate storage unit and steam space) in order to condense the steam fed therein from the steam turbine.

According to one possible aspect of the invention, the condensate storage unit is fluidically connected to, for example, a district heating network. Consequently, the condensed water drawn from the condensate storage unit can be fed to an external consumer for further use.

Dividing the steam space and the condensate storage unit while at the same time providing a steam storage unit thus makes it possible to use waste heat from the gas turbine power plant at at least two different temperatures and at different times. In particular, the steam in the steam storage unit makes it possible to use waste heat at a higher temperature, for example for conversion back into electrical energy, wherein by means of the condensate storage unit, waste heat, typically at a lower temperature, can be used for example for the supply of district heating. In particular, this low-temperature heat available in the condensate storage unit is typically not used in conventional power plant arrangements.

It is to be noted at this point that the thermally conditioned water in the steam storage unit can be temporarily stored both as gaseous water and in its liquid form. Advantages are given to temporary storage under pressure in the superheated state.

According to a first embodiment of the method according to aspects of the invention, it is provided that it further comprises a step of drawing water from a cold water storage unit and supplying the water to the first heat exchanger for thermal conditioning. The cold water storage unit, which is integrated into the steam circuit, makes it possible to temporarily store the liquid, as-yet thermally untreated water which is intended to be thermally conditioned using the heated gas stream from the gas turbine. Storage of the water in the cold water storage unit makes it possible to form a closed steam circuit without the need for an external liquid water supply. Thus, the method according to the invention not only protects resources but also contributes to the energy efficiency of the overall method.

According to a further embodiment of the invention, it further comprises a step of discharging condensed water from the condensate storage unit into the cold water storage unit. This discharging step can occur after the supply of condensed water from the steam space to the condensate storage unit. Consequently, the method according to the embodiment makes increased flexibilization possible since different quantities of thermal energy can be removed from the steam circuit at different times.

According to a further embodiment of the invention, it further comprises a step of heating the water stored in the steam storage unit by means of a heating device. The heating device used in this context is an electrically operated resistance heating device. Other heating devices or other heating methods can however also be used. The additional heating of the water stored in the steam storage unit makes it possible to increase the thermal energy content of the water before the latter is drawn off, for example as steam. However, increasing the energy content also increases the quantity of electrical energy provided by means of the steam turbine in discharging operation. This electrical energy can occasionally be prepared at a higher temperature and with improved efficiency of the operation of the steam turbine. According to the embodiment, the step of heating the steam stored in the steam storage unit therefore makes it possible to improve the overall efficiency of the discharging operation.

According to a further embodiment of the invention, it comprises a step of supplying at least part of the steam, after interaction with the steam turbine, to a condenser for condensing steam, wherein in particular the water condensed in this way is supplied to the cold water storage unit. According to the embodiment, therefore, at least part of the heat of the steam is removed in a condenser. The heat thus transferred to the condenser can possibly be made useful in a further process. Typically, however, this heat is simply discarded. Supplying the steam to the condenser bypasses the steam space and the condensate storage unit, such that it is no longer possible to store the steam as water in the condensate storage unit. Moreover, in the condenser the heat is essentially prepared either for temporally immediate use or to be discarded, wherein in particular the water condensed in the condenser is supplied to the cold water storage unit for renewed later thermal conditioning in charging operation. As a consequence of the steam space and the condensate storage unit being bypassed, it is then possible for the quantity of condensed water stored in the condensate storage unit to be suitably adjusted according to later use in charging operation. It is in particular possible that the later application for utilizing the condensed water temporarily stored in the condensate storage unit requires a lower heat content than is contained in all of the steam exiting the steam turbine.

According to a particular embodiment of the method according to the invention, further provided is a step for thermally conditioning the intake air supplied to the gas turbine by means of a second heat exchanger which is supplied with condensed water from the condensate storage unit, wherein in particular the condensed water is supplied to the cold water storage unit after interaction with the second heat exchanger. The intake air can be thermally conditioned by means of an intermediate circuit. The intermediate circuit is based e.g. on glycol as heat transport medium. The method according to the embodiment permits the thermal conditioning of the intake air supplied to the gas turbine, making possible an improved combustion process during electricity-producing regular operation of the gas turbine. It is at the same time apparent that the physical parameters of the exhaust gas exiting the gas turbine during this combustion are also improved for subsequent use. Because of the residual heat of the condensed steam, temporarily stored in the condensate storage unit, it is then possible to improve the efficiency of the gas turbine operation provided for electricity generation and thus to increase the overall efficiency of the gas power plant.

According to a further aspect of the present method, the generator is operated as a motor using excess current. The excess current is drawn from the public supply networks at times at which there is oversupply of electrical energy. This is particularly cost-effective and may even result in payment for the quantity of electrical power drawn. As a consequence, the method according to the embodiment is distinguished by a particularly high overall efficiency.

A further aspect of the method according to the invention provides that the generator is operated as a motor in such a manner that the gas stream has a temperature of at least 100° C., or at least 150° C. The gas stream exiting the gas turbine is consequently suitable for conditioning water in the steam circuit for a subsequent steam process.

A further embodiment of the method according to the invention provides that, while the generator is operated as a motor, no fuel is supplied to the gas turbine. Consequently, during charging operation, only electrical energy is transformed into thermal energy.

An alternative to this is however an embodiment in which, while the generator is operated as a motor, fuel is supplied to the gas turbine in a quantity smaller than a quantity supplied to the gas turbine during current-generating regular operation. Consequently, the energy content of the gas stream exiting the gas turbine is additionally raised by the combustion of fuel supplied to the gas turbine. However, the combustion of the fuel does not in this context serve primarily to drive the turbine stage of the gas turbine, as for example during current-generating regular operation, but merely to thermally condition the gas stream exiting the gas turbine. In particular, additional fuel firing occurs primarily in order to raise the exit temperature of the gas stream when the quantity of available excess current is smaller than the quantity which corresponds to the maximum drive power of the gas turbine. By appropriate dosing of the quantity of fuel supplied to the gas turbine, the temperature of the gas stream exiting the gas turbine can be set appropriately. In particular, the supply of fuel makes it possible to achieve a temperature of the gas stream exiting the gas turbine of at least 200° C.

According to a first embodiment of the gas power plant according to the invention, the steam storage unit has a heating device which is designed to supply further thermal energy to the steam stored in the steam storage unit. In a manner corresponding to an alternative embodiment, the heating device can also be arranged upstream of the steam storage unit, such that the water supplied to the steam storage unit is already provided with additional thermal energy before it enters the steam storage unit. It is however advantageous for the heating device to be arranged in the steam storage unit itself, such that the water stored therein can be provided with heat also while it is stored. Especially in the case of storage over periods of several hours, such a heating device integrated into the steam storage unit can be advantageous in order to keep the temperature of the water sufficiently high for the subsequent steam process.

According to a further embodiment of the invention, the gas power plant further comprises a condenser which is fluidically connected to the steam turbine such that it can be supplied with at least some of the steam from the steam turbine, wherein, after condensing in the condenser, the steam can be supplied to the cold water storage unit which is fluidically connected to the condenser. As already explained above, the condenser makes it possible to immediately use the heat still contained in the steam from the steam turbine. Moreover, the condenser makes it possible to bypass the steam space and the condensate storage unit. However, it is also possible according to the embodiment to dispense with the condenser which removes some of the heat of the steam exiting the steam turbine.

According to a further embodiment of the invention, there is further provided a second heat exchanger in the gas power plant which is fluidically connected between the condensate storage unit and the cold water storage unit and is designed to thermally condition the intake air supplied to the gas turbine. The second heat exchanger thus makes it possible to make use of the residual heat of the condensed water temporarily stored in the condensate storage unit, such that the intake air supplied to the gas turbine is heated. Heating the intake air improves not only the combustion process during current-generating regular operation of the gas turbine, but also the gas outlet parameters of the exhaust gas exiting the gas turbine after combustion.

The invention will be explained in detail below with respect to individual embodiments. The fact that this discussion is limited to individual embodiments does not represent a restriction of the overall claimed subject matter.

It is further to be noted that the embodiments represented in the figures below are to be understood as merely schematic and again cannot represent a restriction with respect to a concrete embodiment of the claimed subject matter.

### BRIEF DESCRIPTION OF THE DRAWINGS

In the figures:

FIG. 1 is a schematic representation of the processes during operation of one embodiment of a gas power plant 1 according to the invention during charging operation;

FIG. 2 is a schematic representation of the processes taking place, in the embodiment shown in FIG. 1 of the gas power plant 1 according to the invention, during discharging operation;

FIG. 3 is a schematic representation of the processes taking place, in the embodiment shown in FIGS. 1 and 2 of the gas power plant 1 according to the invention, during shutdown operation;

FIG. 4 is a flow chart representation of an embodiment of the method according to the invention for operating a gas power plant.

### DETAILED DESCRIPTION OF INVENTION

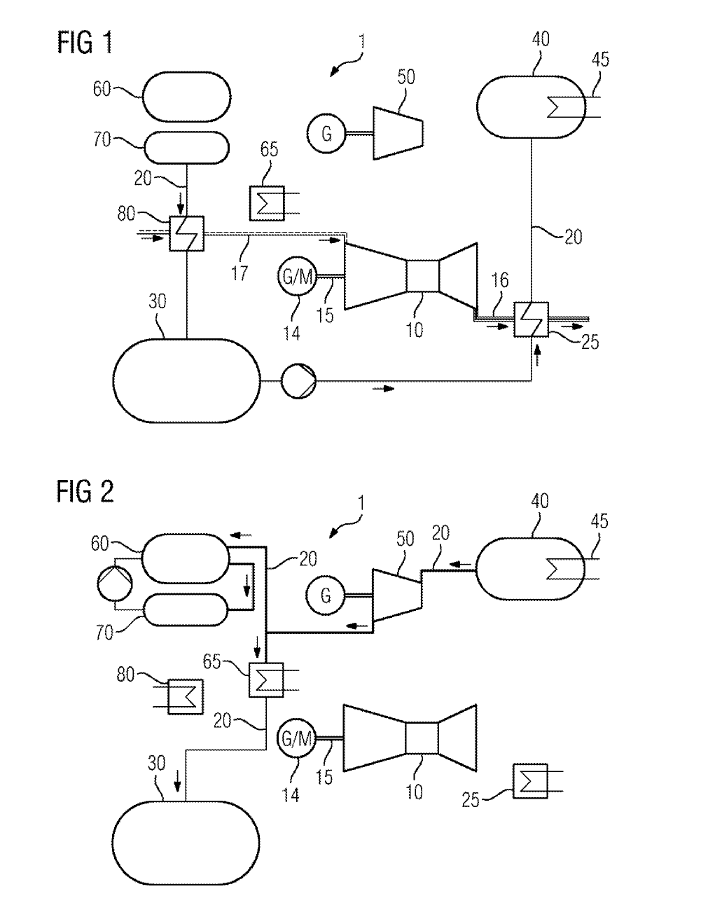

FIG. 1 shows a schematic representation of individual processes in an embodiment of a gas power plant 1 according to the invention during charging operation. According to this, a gas turbine 10 of a gas power plant 1, which is connected via a shaft 15 to a generator 14 which can also be operated as a motor, is operated as a motor by the generator 14. In this context, the intake air 17 is first compressed—essentially adiabatically—in a compressor section of the gas turbine 10, wherein the temperature of the intake air 17 so compressed is increased. It is also possible, according to the embodiment, that fuel is supplied to the combustion chamber of the gas turbine 10 in order to further raise the temperature, which fuel is burnt as the compressed air passes through the combustion chamber. The combustion heat thus produced is transferred to the exhaust gas and raises the temperature and heat content thereof. Upon exiting the gas turbine, this air, treated in this manner, consequently establishes a gas stream 16 whose temperature is above that of the intake air 17.

The gas stream 16 is then supplied to a first heat exchanger 25 by means of which the heat of the gas stream 16 is at least partially transferred to water in a steam circuit 20. In this context, the water is drawn from a cold water storage unit 30, wherein the water flow in the steam circuit 20 can be regulated by means of a flow generator (pump) which is not provided with a reference sign.

Once the water in the steam circuit 20 has been thermally conditioned, it is supplied to a steam storage unit 40. In order to further appropriately adjust the heat content of the water stored in the steam storage unit 40, a heating device 45 is also provided in the steam storage unit 40. It is possible by means of this heating device 45 to supply sufficient or increased heat to the water stored in the steam storage unit 40, in order to make an advantageous conversion back into electrical power, by means of a steam process, possible.

In order to appropriately thermally treat the intake air 17 supplied to the gas turbine 10, it is further provided to draw condensed water from the condensate storage unit 70 and to supply it to the cold water storage unit 30 via the second heat exchanger 80. In this context, at least some of the residual heat in the condensed water is transferred to the intake air 17 before the latter is fed to the gas turbine 10. This results in an increase in the temperature of the intake air 17, whereby an increased quantity of heat can be supplied to the steam storage unit 40.

FIG. 2 is a schematic representation of individual processes of the embodiment shown in FIG. 1 of the gas power plant 1 according to the invention, during discharging operation. In this context, the water stored in the steam storage unit 40 is now supplied to the steam turbine 50, for example in the form of steam, wherein the steam turbine extracts heat from the water to produce electrical current. The steam exiting the steam turbine 50 is supplied, via the steam circuit 20 and in predetermined fractions, to a steam space 60 and/or a condenser 65. By means of the provision of appropriate adjustment means (valves), the individual fractions can be suitably adjusted with respect to each other.

The steam supplied to the steam space 60 condenses in the steam space 60 and is transferred into the condensate storage unit 70 as liquid water. In order to support the condensation process in the steam space 60, liquid water from the condensate storage unit 70 is passed into the steam space 60, for example by means of a suitable pump device (not shown here). In this context, it is necessary that the condensate storage unit 70 is already filled with a sufficient quantity of condensed water before the discharging operation, such that condensation in the stream space 60 can be made possible.

A further fraction of the steam exiting the steam turbine 50 can also be supplied to the condenser 65 which makes condensation of the steam possible. The water condensed in the condenser 65 is then supplied to the cold water storage unit 30 via the steam circuit 20. Later, in a new cycle, the water stored in the cold water storage unit 30 is thermally conditioned in the first heat exchanger 25 when the gas power plant 1 is in charging operation. By feeding a fraction of the steam exiting the gas turbine 50 into the condenser 65, some of the heat in the steam bypasses the steam space 60 and the condensate storage unit 70.

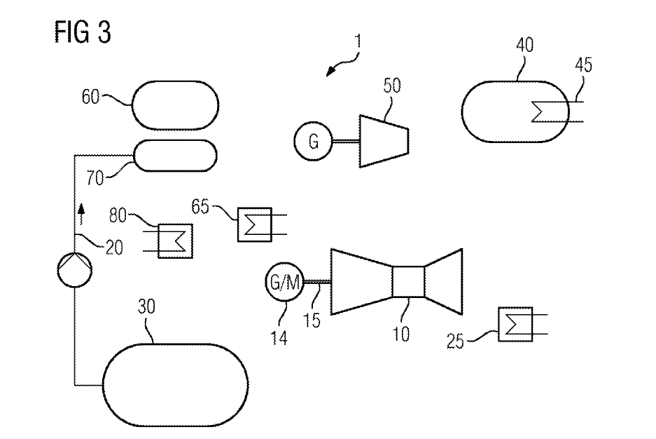

FIG. 3 shows processes of the gas power plant 1 shown in FIGS. 1 and 2, during shutdown operation. Shutdown operation is in this case characterized in that neither is the gas turbine 10 in regular operation for current generation, nor is the generator 14 being operated as a motor for providing heat to the first heat exchanger 25. During this operating state, water in the cold water storage unit 30 is transferred to the condensate storage unit 70 in order that, in particular during discharging operation, the latter has enough water at its disposal to be able to ensure the condensation of the steam exiting the steam turbine 50.

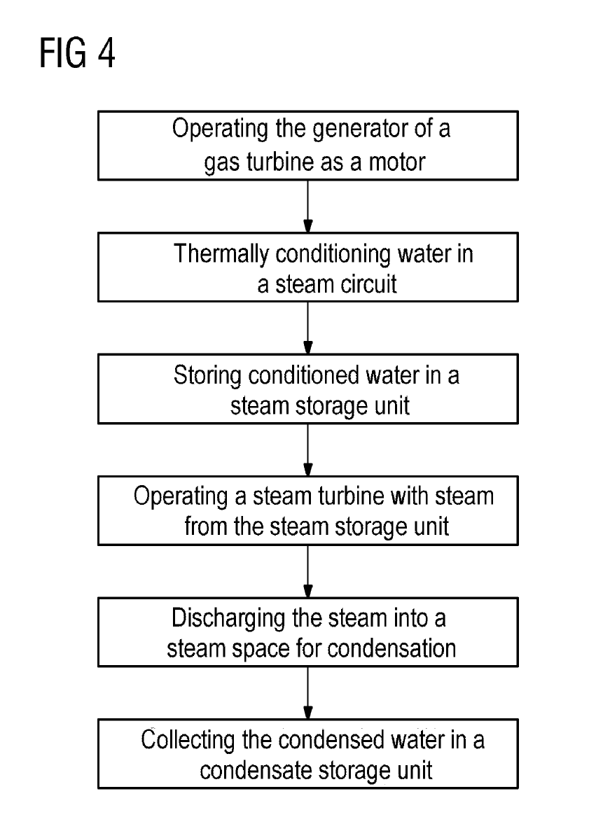

FIG. 4 is a flow chart representation of an embodiment of the method according to the invention for operating a gas power plant 1. In this context, the gas power plant comprises a gas turbine 10 which is connected to a generator 14 that can also be operated as a motor, and which is thermally coupled to a steam circuit 20 via a first heat exchanger 25, wherein the method according to the embodiment comprises the following steps: first the generator 14 connected to the gas turbine 10 is operated as a motor. Water in a steam circuit 20 can be thermally conditioned using the thermally conditioned gas stream 16 exiting the gas turbine 10. After this thermal conditioning, the water thus conditioned is stored in a steam storage unit 40 and is held ready for later use. During later discharging operation, the steam turbine 50 included in the gas power plant 1 is operated using the water from the steam storage unit 40. The steam exiting the steam turbine 50 is discharged for condensation. The discharge takes place in a steam space 60. The water condensed in the steam space 60 is again collected in a condensate storage unit 70 for further, later use, wherein the steam space 60 and the condensate storage unit 70 are two separate containers connected by at least one line, and wherein in particular the steam space 60 can be supplied with the condensed water from the condensate storage unit 70.

Further embodiments result from the subclaims.

1-14. (canceled)

15. A method for operating a gas power plant, comprising a gas turbine which is connected to a generator that can also be operated as a motor, and which is thermally coupled to a steam circuit via a first heat exchanger, the method comprising:
operating the generator as a motor such that a heated gas stream exits the gas turbine;
thermally conditioning water in the steam circuit via the first heat exchanger by the heated gas stream;
storing the thermally conditioned water in a steam storage unit;
operating a steam turbine with steam drawn from the steam storage unit;
discharging the steam, after interaction with the steam turbine, into a steam space for condensation;
collecting the condensed water in a condensate storage unit, wherein the steam space and the condensate storage unit are two separate containers connected by at least one line, and wherein the steam space can be supplied with the condensed water from the condensate storage unit; and
thermally conditioning the intake air supplied to the gas turbine by a second heat exchanger which is supplied with condensed water from the condensate storage unit, wherein the condensed water is supplied to the cold water storage unit after interaction with the second heat exchanger.

16. The method as claimed in claim 15, further comprising:
drawing water from a cold water storage unit and supplying the water to the first heat exchanger for thermal conditioning.

17. The method as claimed in claim 15, further comprising:
discharging condensed water from the condensate storage unit into the cold water storage unit.

18. The method as claimed in claim 15, further comprising:
heating the water stored in the steam storage unit by a heating device.

19. The method as claimed in claim 15, further comprising:
supplying at least part of the steam, after interaction with the steam turbine, to a condenser for condensing steam, wherein the water condensed in this way is supplied to the cold water storage unit.

20. The method as claimed in claim 15, wherein
the generator is operated as a motor using excess current.

21. The method as claimed in claim 15, wherein
the generator is operated as a motor in such a manner that the gas stream has a temperature of at least 100° C.

22. The method as claimed in claim 15, wherein
while the generator is operated as a motor, no fuel is supplied to the gas turbine.

23. The method as claimed in claim 15, wherein
while the generator is operated as a motor, fuel is supplied to the gas turbine in a quantity smaller than a quantity supplied to the gas turbine during current-generating regular operation.

24. A gas power plant, comprising
a gas turbine which is connected to a generator that can also be operated as a motor, and which is thermally coupled to a steam circuit via a first heat exchanger such that, when the generator is operated as a motor, a gas stream exiting the gas turbine thermally conditions water in the steam circuit drawn from a cold water storage unit, wherein the first heat exchanger is furthermore fluidically connected to a steam storage unit such that the water can be stored as steam in the steam storage unit after thermal conditioning,
a steam turbine which is fluidically connected to the steam storage unit such that it can be supplied with steam from the steam storage unit, wherein the steam, after interaction with the steam turbine, is fed to a steam space interacting fluidically with a condensate storage unit for condensation, and wherein the condensate storage unit is fluidically connected to the cold water storage unit such that condensed water from the condensate storage unit can be supplied to the cold water storage unit, and wherein the steam space and the condensate storage unit are two separate containers connected by at least one line, and wherein the steam space can be supplied with the condensed water from the condensate storage unit, and
a second heat exchanger which is fluidically connected between the condensate storage unit and the cold water storage unit, the second heat exchanger designed to thermally condition the intake air supplied to the gas turbine.

25. The gas power plant as claimed in claim 24, wherein
the steam storage unit has a heating device which is designed to supply further thermal energy to the steam stored in the steam storage unit.

26. The gas power plant as claimed in claim 24, wherein
the condensate storage unit is fluidically connected to a district heating network.

27. The method as claimed in claim 21, wherein
the generator is operated as a motor in such a manner that the gas stream has a temperature of at least 150° C.
